(19) United States
(12) Patent Application Publication
(10) Pub. No.: US 2021/0226497 A1
(43) Pub. Date: Jul. 22, 2021

(54) WINDING STATOR AND ELECTRIC MOTOR

(71) Applicant: Shanghai PanGood Power Technology Co., Ltd., Shanghai (CN)

(72) Inventors: Li Xia, Shanghai (CN); Lei Tang, Shanghai (CN); Guangquan Zhang, Shanghai (CN)

(21) Appl. No.: 16/629,439

(22) PCT Filed: Feb. 28, 2019
(86) PCT No.: PCT/CN2019/076537

§ 371 Date: Jan. 8, 2020

(30) Foreign Application Priority Data
Aug. 23, 2018 (CN) 201810964681.1

(51) Int. Cl. H02K 3/28; H02K 9/22; H02K 11/215

(52) U.S. Cl. CPC H02K 3/28; H02K 2203/03; H02K 11/215; H02K 9/223

(57) ABSTRACT

A winding stator and an electric motor are provided, relating to the technical field of electric motors. The winding stator comprises at least one phase of windings, each phase of windings comprises at least one insulating carrying plate and at least one serpentine coil having a starting end and a terminating end, the at least one insulating carrying plate is provided with the serpentine coil, and the serpentine coil is arranged on the insulating carrying plate in a shape of a bent spiral sheet, wherein the serpentine coil comprises inward bent portions, outward bent portions and working portions, and wherein each of the working portion is in a fan-shaped sheet-like structure, an inner arc end of the fan-shaped sheet-like structure is connected with the inward bent portion, and an outer arc end of the fan-shaped sheet-like structure is connected with the outward bent portion.

### CROSS-REFERENCE TO RELATED APPLICATION

The present disclosure claims the priority to the Chinese patent application with the filing number 2018109646811 filed on Aug. 23, 2018 with the Chinese Patent Office, and entitled “Winding Stator and Electric motor”, the contents of which are incorporated herein by reference in entirety.

### TECHNICAL FIELD

The present disclosure relates to the technical field of electric motors, and particularly to a winding stator and an electric motor.

### BACKGROUND ART

In the field of electric motors, most electric motors currently available in the market are radial magnetic field electric motors, that is to say, a magnetic field in an electric motor driving the electric motor to rotate has a magnetic field direction perpendicular to a rotating shaft of the electric motor. With the breakthrough of new materials and new technologies, axial magnetic field electric motors (also called as disc electric motors) start to rise slowly. In the prior art, the disc electric motors are restricted by internal structures, causing a big internal resistance of the electric motor, further reducing the efficiency of converting electric energy to mechanical energy when the electric motor is operated.

### SUMMARY

In order to overcome the above shortcomings in the prior art, the present disclosure provides a winding stator and an electric motor so as to solve the above problems.

In order to achieve the above object, a technical solution provided in an embodiment of the present disclosure is as follows.

In a first aspect, an embodiment of the present disclosure provides a winding stator, applicable to an electric motor, wherein the winding stator includes at least one phase of winding, each phase of the winding comprising at least one insulating carrying plate and a serpentine coil having a starting end and a terminating end, the at least one insulating carrying plate is provided with the serpentine coil, and the serpentine coil is arranged on the insulating carrying plate in a shape of bent spiral sheet, wherein the serpentine coil includes inward bent portions, outward bent portions and working portions, the working portion is in a fan-shaped sheet-like structure, an inner arc end of the fan-shaped sheet-like structure is connected with the inward bent portion, and an outer arc end of the fan-shaped sheet-like structure is connected with the outward bent portion.

Optionally, the above serpentine coil is provided with at least one hollowed gap, and the at least one hollowed gap is configured to divide the serpentine coil into a plurality of sheet-like conductors connected in parallel.

Optionally, the above hollowed gap is provided with an insulation material configured to insulatedly isolate conductors at two sides of the hollowed gap.

Optionally, the outer arc end of the above fan-shaped sheet-like structure is in a form of a trapezoidal sheet, wherein a length of an upper base of the trapezoidal sheet is smaller than a length of a lower base of the trapezoidal sheet, and an upper base side of the trapezoidal sheet is connected with the outward bent portion.

Optionally, each phase of the winding includes a plurality of serpentine coils and insulating carrying plates respectively configured to carry the plurality of serpentine coils, and in in-phase windings, various serpentine coils form the winding stator through serial or parallel connection of corresponding starting ends with respective terminating ends.

Optionally, the number of the insulating carrying plates is multiple; in in-phase windings, the insulating carrying plate is provided with a connection through hole, and the connection through hole is configured for serial connection of the serpentine coils on each of the insulating carrying plates in the in-phase winding.

Optionally, the insulating carrying plate is provided with a plurality of strip-shape slots, and wherein the plurality of strip-shape slots are arranged on the insulating carrying plate radially in a circular shape, and the working portion is accommodated in at least part of the strip-shape slots among the plurality of strip-shape slots.

Optionally, the number of the insulating carrying plate is multiple; in in-phase windings, the working portions and the insulating carrying plate corresponding to the working portions are both provided with at least one conductive through hole, wherein the conductive through hole is provided with a conductive connector in contact with the working portions corresponding to the serpentine coil on each layer, and the conductive connector is configured to connect the working portions on various insulating carrying plates in parallel.

Optionally, the conductive connector is a conductive plating layer provided on an inner wall of the conductive through hole, and the insulating carrying plate corresponding to an edge of the conductive through hole is provided with at least one isolation through hole configured to prevent the conductive connector from creating an eddy current loop.

Optionally, the phase number of the above windings is three, individual serpentine coils of in-phase windings are distributed on a radial cross section in the same manner, windings in different phases are distributed on a radial cross section with an angle of 120° therebetween, and connected in a Y shape.

Optionally, the in-phase windings further are provided with a power supply terminal, and the power supply terminal is connected with the starting end or the terminating end.

Optionally, the above insulating carrying plate is a PCB board, and the PCB board is provided with an axial hole allowing a rotor of the electric motor to pass therethrough.

Optionally, the winding stator further includes a Hall sensing layer, a supplemental layer and a Hall sensor, the Hall sensing layer and the supplemental layer are provided opposite at an interval, the windings of individual phase are located between the Hall sensing layer and the supplemental layer, and all of them are connected with the Hall sensor, and the Hall sensing layer and the supplemental layer are both configured to sense a pole alternating signal and transfer it to the Hall sensor.

Optionally, the insulating carrying plate is provided with a plurality of heat-dissipating parts, and the heat-dissipating parts are configured to transfer heat generated by the serpentine coil to the insulating carrying plate.

In a second aspect, an embodiment of the present disclosure provides an electric motor, including rotor disks provided opposite at an interval and the above winding stator, the winding stator being located between two of the rotor disks.

Compared with the prior art, the winding stator and the electric motor provided in the present disclosure at least have the following beneficial effects: the winding stator includes at least one phase of winding, each phase of winding includes at least one insulating carrying plate and a serpentine coil having a starting end and a terminating end, at least one insulating carrying plate is provided with the serpentine coil, and the serpentine coil is arranged on the insulating carrying plate in a shape of a bent spiral sheet, wherein the serpentine coil includes the inward bent portions, the outward bent portions and the working portions, and wherein the working portions are in a fan-shaped sheet-like structure, the inner arc end of the fan-shaped sheet-like structure is connected with the inward bent portion, and the outer arc end of the fan-shaped sheet-like structure is connected with the outward bent portion. In the winding stator of this embodiment, by configuring the working portions in the fan-shaped sheet-like structure, an area of a conductive portion at an outer diameter of the winding stator can be increased, and the resistance of the windings can be reduced, such that when the electric motor is operated, the efficiency of converting electric energy to mechanical energy is improved.

In order to make the above objects, features and advantages of the present disclosure more apparent and understandable, embodiments of the present disclosure are particularly illustrated below in combination with attached accompanying drawings to make detailed description as follows.

### BRIEF DESCRIPTION OF DRAWINGS

In order to more clearly illustrate technical solutions of embodiments of the present disclosure, accompanying drawings which need to be used for description of the embodiments will be introduced below briefly. It should be understood that the accompanying drawings below merely show some embodiments of the present disclosure, therefore, they should not be considered as limitation on the scope, and a person ordinarily skilled in the art still could obtain other relevant accompanying drawings according to these accompanying drawings, without inventive efforts.

FIG. 1 is a first radial cross-section schematic diagram of a first phase winding in a winding stator provided in an embodiment of the present disclosure.

FIG. 2 is a first structural schematic diagram of a working portion in the winding stator provided in an embodiment of the present disclosure.

FIG. 3 is a second structural schematic diagram of a working portion in the winding stator provided in an embodiment of the present disclosure.

FIG. 4 is a second radial cross-section schematic diagram of the first phase winding in the winding stator provided in an embodiment of the present disclosure.

FIG. 5 is a third radial cross-section schematic diagram of the first phase winding in the winding stator provided in an embodiment of the present disclosure.

FIG. 6 is a first radial cross-section schematic diagram of a second phase winding in the winding stator provided in an embodiment of the present disclosure.

FIG. 7 is a first radial cross-section schematic diagram of a third phase winding in the winding stator provided in an embodiment of the present disclosure.

FIG. 8 is a fourth radial cross-section schematic diagram of the first phase winding in the winding stator provided in an embodiment of the present disclosure.

FIG. 9 is a fifth radial cross-section schematic diagram of the first phase winding in the winding stator provided in an embodiment of the present disclosure.

FIG. 10 is a second radial cross-section schematic diagram of a second phase winding in the winding stator provided in an embodiment of the present disclosure.

FIG. 11 is a third radial cross-section schematic diagram of the second phase winding in the winding stator provided in an embodiment of the present disclosure.

FIG. 12 is a second radial cross-section schematic diagram of the third phase winding in the winding stator provided in an embodiment of the present disclosure.

FIG. 13 is a third radial cross-section schematic diagram of the third phase winding in the winding stator provided in an embodiment of the present disclosure.

FIG. 14 is a radial cross-section schematic diagram of a Hall sensing layer in the winding stator provided in an embodiment of the present disclosure.

FIG. 15 is a radial cross-section schematic diagram of a supplemental layer in the winding stator provided in an embodiment of the present disclosure.

FIG. 16 is a sixth radial cross-section schematic diagram of the first phase winding in the winding stator provided in an embodiment of the present disclosure.

FIG. 17 is a seventh radial cross-section schematic diagram of the first phase winding in the winding stator provided in an embodiment of the present disclosure.

FIG. 18 is a third radial cross-section schematic diagram of the working portion in the winding stator provided in an embodiment of the present disclosure.

FIG. 19 is a fourth radial cross-section schematic diagram of the working portion in the winding stator provided in an embodiment of the present disclosure.

FIG. 20 is an eighth radial cross-section schematic diagram of the first phase winding in the winding stator provided in an embodiment of the present disclosure.

### REFERENCE SIGNS

110—first phase winding; 111—first insulating carrying plate; 112—fourth insulating carrying plate; 120—second phase winding; 121—second insulating carrying plate; 122—fifth insulating carrying plate; 130—third phase winding; 131—third insulating carrying plate; 132—sixth insulating carrying plate; 140—serpentine coil; 141—inward bent portion; 142—outward bent portion; 143—working portion; 144—hollowed gap; 145—connection through hole; 146—power supply terminal; 147—three-phase neutral point; 148—axial hole; 151—starting end; 152—terminating end; 161—heat-dissipating part; 162—strip-shape slot; 170—Hall sensing layer; 171—Hall sensor; 180—supplemental layer; 191—conductive through hole; 192—isolation through hole.

### DETAILED DESCRIPTION OF EMBODIMENTS

Technical solutions in embodiments of the present disclosure will be described below clearly and completely in combination with accompanying drawings in the embodiments of the present disclosure. Apparently, the embodiments described are only some embodiments of the present disclosure, rather than all embodiments. Generally, components in the embodiments of the present disclosure described and shown in the accompanying drawings herein can be arranged and designed in various different configurations.

Therefore, the following detailed description of the embodiments of the present disclosure provided in the accompanying drawings is not intended to limit the scope claimed by the present disclosure, but merely represents chosen embodiments of the present disclosure. Based on the embodiments of the present disclosure, all other embodiments obtained by a person skilled in the art without using inventive efforts fall within the scope of protection of the present disclosure.

It should be noted that similar reference signs and letters represent similar items in the following accompanying drawings, therefore, once a certain item is defined in one accompanying drawing, it is not needed to be further defined or explained in subsequent accompanying drawings.

In the description of the present disclosure, it should be indicated that orientational or positional relationships indicated by terms such as “middle”, “upper”, “lower”, “inner”, and “outer” are based on orientational or positional relationships as shown in the accompanying drawings, or orientational or positional relationships of a product of the present disclosure when being conventionally placed in use, merely for facilitating describing the present disclosure and simplifying the description, rather than indicating or implying that related devices or elements have to be in the specific orientation or configured and operated in a specific orientation, therefore, they should not be construed as limitation on the present disclosure. Besides, terms such as “first”, “second”, “third”, “fourth”, “fifth”, and “sixth” are merely for distinctive description, but should not be construed as indicating or implying relative importance.

In the description of the present disclosure, it should be indicated that unless otherwise specified and defined explicitly, terms “provide” and “connect” should be construed in a broad sense, for example, it may be fixed connection, and also may be detachable connection, or integrated connection. It may be mechanical connection, and also may be electrical connection. It may be direct connection, indirect connection through an intermediate medium, or inner communication between two elements. For a person ordinarily skilled in the art, specific meanings of the above-mentioned terms in the present disclosure can be understood according to specific circumstances.

In the prior art, the inventor of the present disclosure found upon long-term research and exploration that one of the reasons for causing a big internal resistance of an electric motor is that in a disc electric motor, a plurality of copper clad working portions forming Ampere force are distributed on a circular insulating plate radially in a circular shape, wherein each copper clad working portion is in a straight strip shape, such that the copper is relatively compactly clad on an inner ring of a circular insulating plate, and the copper is relatively sparsely clad on an outer ring, that is, the space of the outer ring is not sufficiently used, thereby resulting in a low copper cladding rate at the outer ring, and a relatively high winding resistance. As the working portion is normally provided in a straight strip shape in the prior art, it is quite difficult to find this technical problem.

In view of the above problems, the inventor of the present disclosure, upon long-term research and exploration, provides following embodiments to solve the above problems. The embodiments of the present disclosure are described in detail below in combination with accompanying drawings. The following embodiments and the features in the embodiments may be combined with each other if there is no conflict.

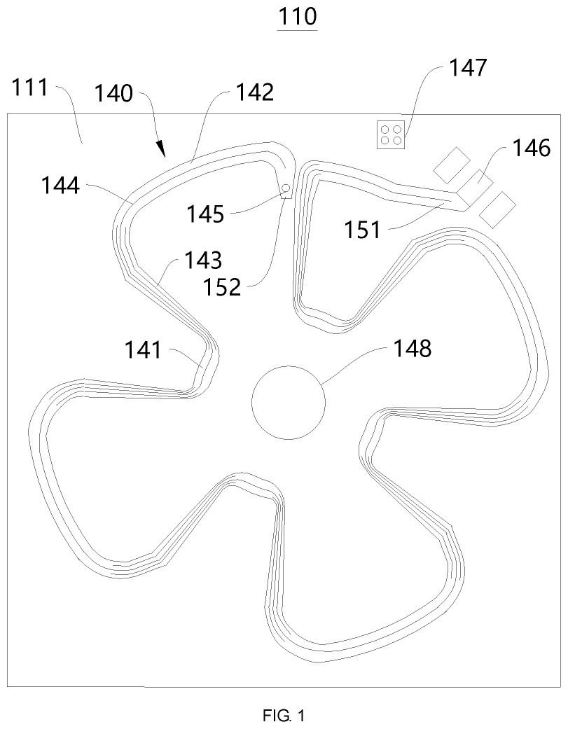

Please referring to FIG. 1 to FIG. 6, an embodiment of the present disclosure provides a winding stator. The winding stator is applicable to an axial magnetic field electric motor (also called as disc electric motor), and the axial magnetic field electric motor can be construed as an electric motor with a magnetic field for driving the electric motor to rotate having a magnetic field direction, which is the same as extension of a rotating shaft of the electric motor. In the winding stator, in-phase serpentine coils 140 on each layer are connected to each other in series or in parallel. In operation, the serpentine coils 140 are energized, the working portions 143 of the serpentine coils 140 are used to make a motion of cutting magnetic field lines of the magnetic field of the electric motor, so as to generate Ampere force (Ampere force refers to a force received by an energized wire in a magnetic field), and drives a rotor to rotate in an axial hole 148 based on the Ampere force generated, so as to convert electric energy to mechanical energy.

In the present embodiment, the serpentine coil 140 is made of an electrically conductive material, which may be, but not limited to, copper, aluminum and so on. The working portions 143 of the serpentine coil 140 are in a fan-shaped sheet-like structure, which can increase an area of an outer diameter region of the working portions 143, so as to be conducive to reducing the electrical resistance of the working portions 143, such that the efficiency of converting electric energy to mechanical energy is increased when the electric motor is operated.

It can be understood that the serpentine coil 140 can be formed by winding a copper sheet. As the copper sheet in the fan-shaped sheet-like structure can make full use of a space of the insulating carrying plate, a broader area of the copper sheet is clad in the outer diameter region of the whole insulating carrying plate. Compared with the strip-shape conductor plate in the prior art, the copper sheet in the fan-shaped sheet-like structure is adopted in the present solution as the working portions 143, so as to increase a conductive cross section area of the working portions 143 in the outer diameter region of the winding stator, decrease an internal resistance of the working portions 143, i.e. thus decrease the electric resistance of the winding stator, and further facilitate improvement on the electric motor's energy conversion efficiency.

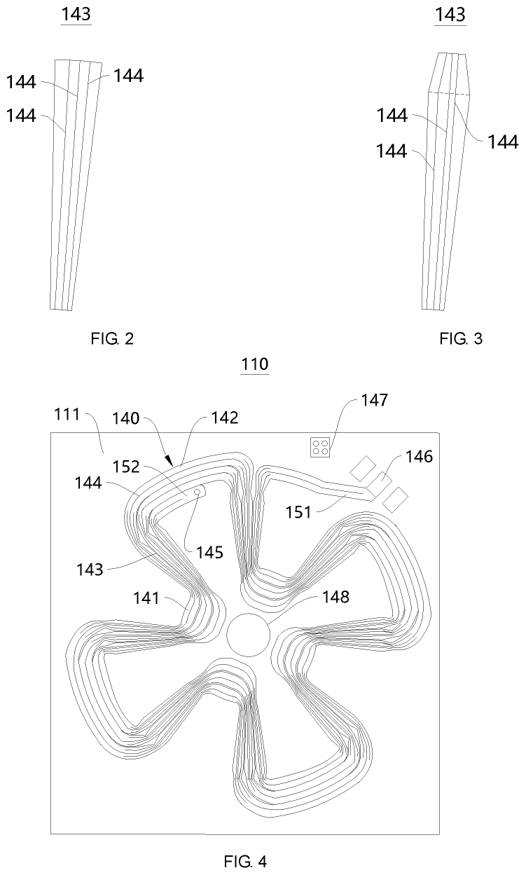

Pleasing combining and referring to FIG. 1 and FIG. 2, FIG. 1 is a first radial cross-section schematic diagram of a first phase winding 110 in a winding stator provided in an embodiment of the present disclosure, and FIG. 2 is a first structural schematic diagram of the working portions 143 in the winding stator provided in an embodiment of the present disclosure. The winding stator provided in the embodiment of the present disclosure includes at least one phase of winding, each phase of winding includes at least one insulating carrying plate and a serpentine coil 140 having a starting end 151 and a terminating end 152, each insulating carrying plate is provided with the serpentine coil 140, and the serpentine coil 140 is arranged on the insulating carrying plate in a shape of bent spiral sheet, wherein the serpentine coil 140 includes inward bent portions 141, outward bent portions 142 and working portions 143, wherein the working portions 143 are in a fan-shaped sheet-like structure, an inner arc end of the fan-shaped sheet-like structure is connected with the inward bent portion 141, and an outer arc end of the fan-shaped sheet-like structure is connected with the outward bent portion 142. Besides, the radial cross section can be construed as a plane perpendicular to an extension of the rotating shaft of the electric motor, and the rotating shaft of the electric motor is perpendicular to a plane where the insulating carrying plate is located.

In the present embodiment, the phase number of windings included in the winding stator may be set according to practical situations, and there may be one phase, and also may be multiple phases (for example, three phases). The number of insulating carrying plates included in each phase of winding may be one and also may be multiple, and a specific number of insulating carrying plates may be set according to practical situations. The number of serpentine coils 140 included in each phase of winding may be the same as the number of insulating carrying plates, and the number of serpentine coils 140 is not specifically defined herein.

It can be understood that each phase of winding may include a plurality of serpentine coils 140 and insulating carrying plates respectively used to carry the plurality of serpentine coils 140, and in in-phase windings, various serpentine coils 140, by means of making corresponding starting ends 151 and respective terminating ends 152 in a serial or parallel connection, form the winding stator.

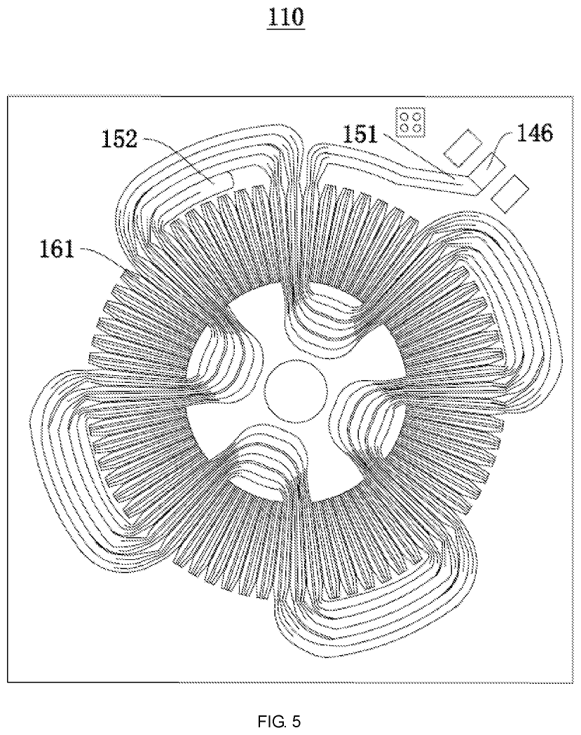

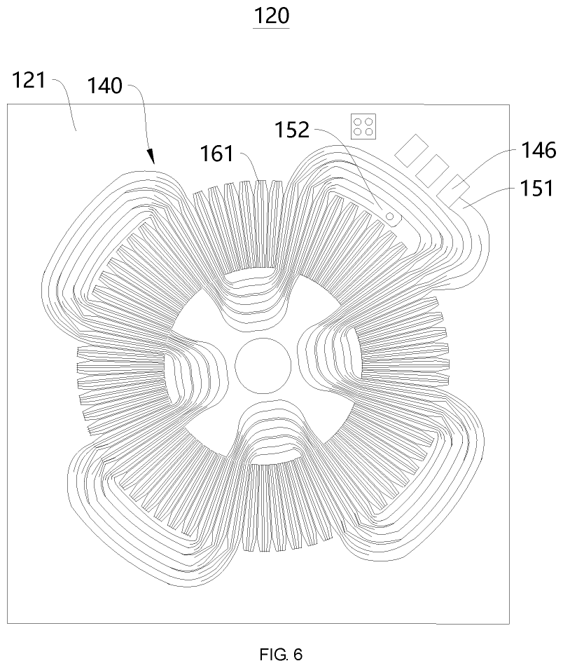

Pleasing combining and referring to FIG. 1 and FIG. 4, FIG. 4 is a second radial cross-section schematic diagram of the first phase winding 110 in the winding stator provided in an embodiment of the present disclosure, wherein one copper sheet of the serpentine coil 140 is an open circle, and one copper sheet can act as one serpentine sub coil. On the insulating carrying plate, a plurality of serpentine sub coils are concentrically connected in series end to end so as to form the serpentine coil 140. For example, in FIG. 1, the serpentine coil 140 can be construed as a spiral sheet formed by bending a copper sheet back and forth into a circular shape, and the serpentine coil 140 also can act as one serpentine sub coil. In FIG. 4, the serpentine coil 140 includes three serpentine sub coils concentrically connected in series end to end.

It needs to be indicated that the number of turns of serpentine coils 140 provided on the insulating carrying plate can be determined according to practical situations, and there may be one turn, and also may be multiple turns, and the number of turns is not specifically limited herein.

In the present embodiment, a profile of the inward bent portion 141 and a profile of the outward bent portion 142 may be both in an arc shape, wherein the inward bent portion 141 is dimensionally smaller than the outward bent portion 142. Each serpentine coil 140 may include a plurality of inward bent portions 141, a plurality of outward bent portions 142 and a plurality of working portions 143, and specific numbers thereof can be set according to practical situations. For example, one serpentine sub coil has four inward bent portions 141, four outward bent portions 142, and eight working portions 143, wherein extensions of the eight working portions 143 usually intersect at a center of the serpentine coil 140.

In the present embodiment, the serpentine coil 140 is provided with at least one hollowed gap 144, and the at least one hollowed gap 144 is configured to divide the serpentine coil 140 into a plurality of sheet-like conductors connected in parallel. For example, in FIG. 2, each of the working portions 143 is divided by three hollowed gaps 144 into four strip-shape sheet-like conductors insulatedly isolated. The hollowed gaps 144 in FIG. 2 can be construed as line parts corresponding to reference signs.

In the above, the hollowed gaps 144 provided can be helpful in preventing a current from forming an eddy current loop on the sheet-like conductors. If the current forms an eddy current loop on the sheet-like conductor, the sheet-like conductor will generate a lot of heat, while the hollowed gap 144 provided can prevent or weaken the generation of the eddy current loop, further being favorable to reducing the generation of heat, such that the electric energy could be converted to more mechanical energy, and output via the rotor, thereby facilitating the improvement on the electric motor's conversion efficiency from electric energy to mechanical energy. It can be understood that compared with the prior art, in a situation that the electric energy consumption is the same, a high power can be output using the electric motor made with the winding stator provided in the present disclosure; alternatively, in a situation that the same power is output, the energy consumption can be reduced using the electric motor made with the winding stator provided in the present disclosure.

In the present embodiment, each hollowed gap 144 is provided with an insulation material configured to insulatedly isolate conductors at two sides of the hollowed gap 144, wherein the insulation material can improve the insulating effect of the conductors at the two sides of the hollowed gap 144, and reduce the risk of generating an electric arc by the conductors at the two sides of the hollowed gap 144. Optionally, the insulation material is a high-temperature-resistant, flame-retardant material, for example, boron nitride, epoxy resin and other materials as an insulation material.

In in-phase windings, a part of the insulating carrying plate corresponding to the starting end 151 or the terminating end 152 is provided with a connection through hole 145, alternatively, parts of the insulating carrying plate corresponding to the starting end 151 and the terminating end 152 are each provided with a connection through hole 145. The connection through hole 145 is configured for a first serpentine coil 140 to be connected in series or in parallel with a second serpentine coil 140 on another insulating carrying plate, wherein the connection through hole 145 also may be replaced by a conductive plating tank, and parallel connection between the serpentine coils 140 on adjacent layers is realized using the conductive plating tank.

In the present embodiment, the in-phase winding further includes a power supply terminal 146, and the power supply terminal 146 is connected with the starting end 151 or the terminating end 152. Each power supply terminal 146 is associated with the through hole or post. Generally, each phase has one pad/through hole/binding post, therefore, a three-phase electric motor has three power supply connection ends as power supply terminals 146.

In the present embodiment, the insulating carrying plate is provided with an axial hole 148 for the rotor of the electric motor to pass therethrough. For example, the insulating carrying plate is a PCB board, and the PCB board is provided with an axial hole 148 for the rotor of the electric motor to pass therethrough.

When the working portions 143 are energized, the rotor of the electric motor is pre-provided at a central portion of the winding stator, and the rotating shaft of the rotor is perpendicular to the insulating carrying plate. The rotor may be provided thereon with a plurality of magnets configured to generate axial magnetic fields, such that each working portion 143 bears a corresponding magnetic force, wherein magnetic fields acting on two adjacent working portions 143 have opposite magnetic poles, such that torques generated by all working portions 143 have the same rotating direction, further driving the rotor of the electric motor to rotate. Pleasing combining and referring to FIG. 2 and FIG. 3, FIG. 3 is a second structural schematic diagram of the working portion 143 in the winding stator provided in an embodiment of the present disclosure. In the present embodiment, the outer arc end of the fan-shaped sheet-like structure is in a form of a trapezoidal sheet, wherein a length of an upper base of the trapezoidal sheet is smaller than a length of a lower base of the trapezoidal sheet, and an upper base side of the trapezoidal sheet is connected with the outward bent portion 142. It can be understood that the outer arc end of the fan-shaped sheet-like structure can be processed through corner cutting, to form the trapezoidal sheet. In the above, the trapezoidal sheet can allow the outer arc ends of two adjacent working portions 143 to have a relatively obvious gap, facilitating connection of the outward bent portion 142 with corresponding outer arc end, besides, also facilitating a user in distinguishing each serpentine sub coil.

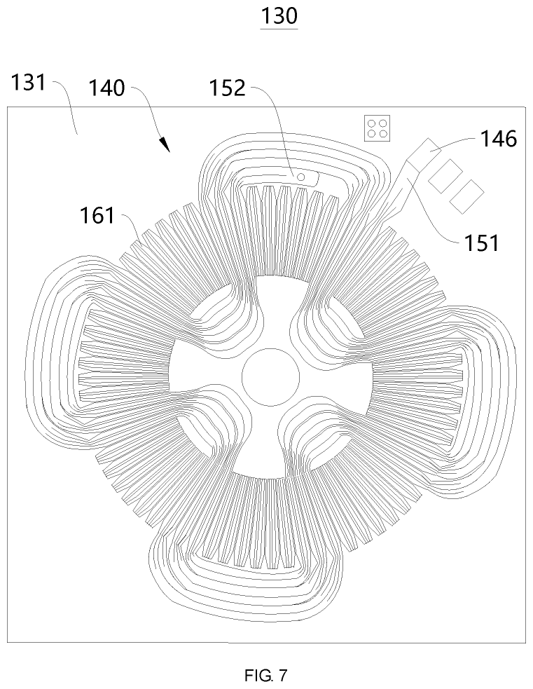

Pleasing combining and referring to FIG. 5 to FIG. 7, FIG. 5 is a third radial cross-section schematic diagram of the first phase winding 110 in the winding stator provided in an embodiment of the present disclosure, FIG. 6 is a first radial cross-section schematic diagram of a second phase winding 120 in the winding stator provided in an embodiment of the present disclosure, and FIG. 7 is a first radial cross-section schematic diagram of the third phase winding 130 in the winding stator provided in an embodiment of the present disclosure, wherein the first phase winding 110 may include a first insulating carrying plate 111, the second phase winding 120 may include a second insulating carrying plate 121, and the third phase winding 130 may include a third insulating carrying plate 131, wherein the number of insulating carrying plates of each phase of winding is the same, and each insulating carrying plate is provided thereon with the serpentine coil 140. The second phase winding 120 and the third phase winding 130 are structurally similar to the first phase winding 110, and for specific structures thereof, reference can be made to the above detailed description of each structure of the first phase winding 110, which will not be repeated redundantly herein.

In the present embodiment, the winding stator may be a stator in a three-phase electric motor, that is, the number of the above at least one phase of winding may be three, the starting end 151 of each phase of winding may be respectively connected with the corresponding power supply terminal 146. In a technical solution in which the serpentine coils are connected in series to form the winding stator, the terminating end 152 of each phase of winding is connected with the same three-phase neutral point 147, such that the three-phase coil windings are connected in a Y shape. In a technical solution in which the serpentine coils are connected in parallel to form the winding stator, individual neutral point is not present.

Specifically, the starting end 151 of the serpentine coil 140 on the first insulating carrying plate 111 (see FIG. 5), the starting end 151 of the serpentine coil 140 on the second insulating carrying plate 121 (see FIG. 6), the starting end 151 of the serpentine coil 140 on the third insulating carrying plate 131 (see FIG. 7) are respectively connected with corresponding power supply terminals 146. The terminating end 152 of the serpentine coil 140 on the first insulating carrying plate 111 (reference can be made to FIG. 5), the terminating end 152 of the serpentine coil 140 on the second insulating carrying plate 121 (reference can be made to FIG. 6), the terminating end 152 of the serpentine coil 140 on the third insulating carrying plate 131 (reference can be made to FIG. 7) may be all connected with the same three-phase neutral point 147, such that the three-phase coil windings are connected in a Y shape, wherein various serpentine coils 140 in the windings in different phases are distributed on a radial cross section by 120° from one another, wherein this angle of difference 120° can be construed as angle of difference of phase angles of various phase currents. The working portions 143 of various serpentine coils 140 of the in-phase winding are distributed on a radial cross section in the same manner, that is, they have an angle of difference of 0°.

Optionally, each insulating carrying plate may be provided with a plurality of heat-dissipating parts 161. The plurality of heat-dissipating parts 161 are configured to transfer heat generated by the serpentine coil 140 to the insulating carrying plate, being helpful in preventing burn-out of the electric motor due to high temperature created by the serpentine coil 140. In the above, each heat-dissipating part 161 may be structurally the same as the working portions 143, and can match with the outward bent portion 142 and the inward bent portion 141, for example, two ends of each heat-dissipating part 161 are respectively connected with the outward bent portion 142 and the inward bent portion 141, and can replace the working portions 143, to realize corresponding functional effect of the working portions 143.

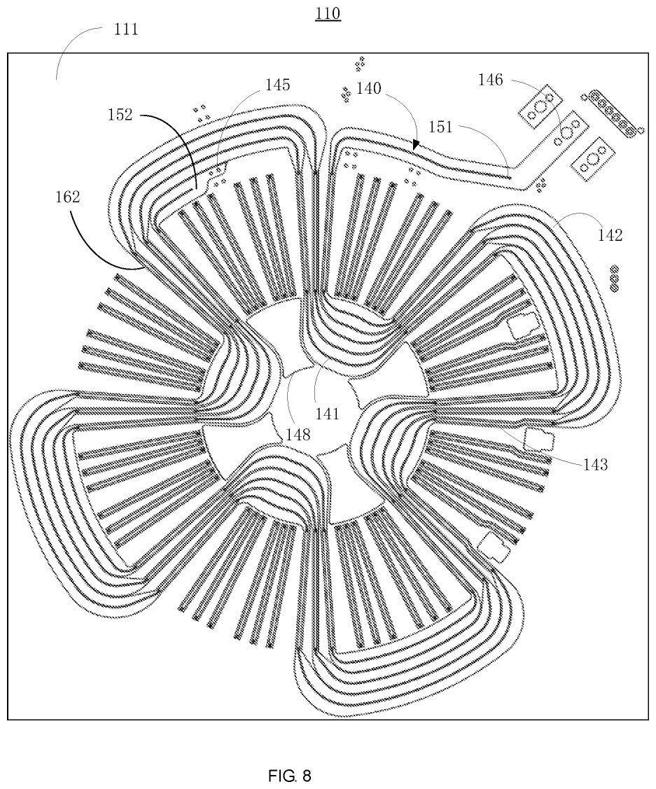

A solution of the winding stator in which the serpentine coils are connected in series is introduced below (corresponding to FIG. 8 to FIG. 15).

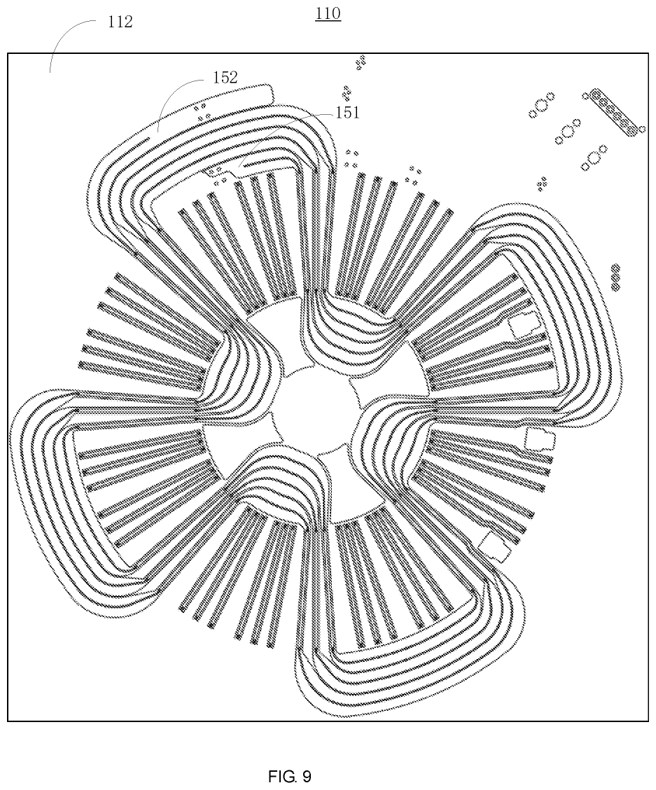

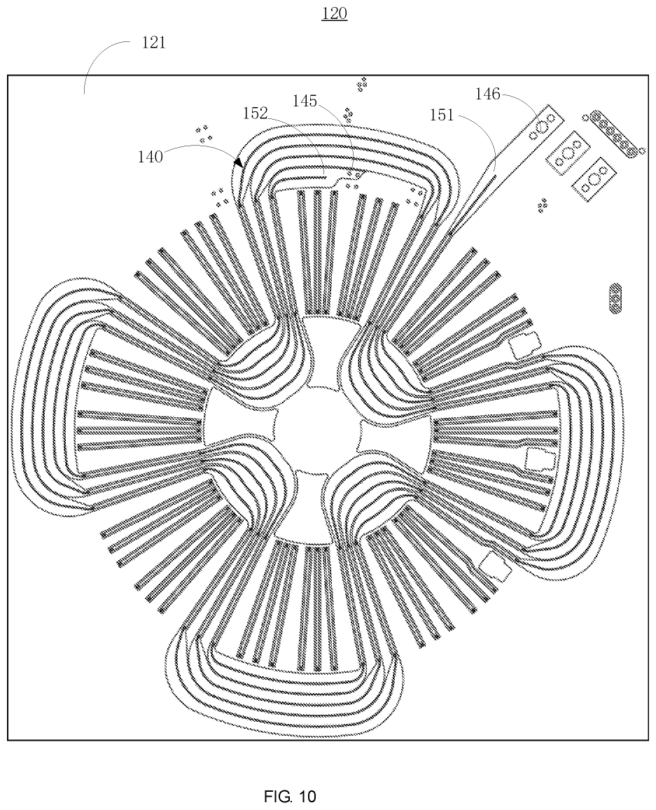

In the present embodiment, the in-phase winding may be in the above form including one insulating carrying plate, but is not merely limited thereto, while it also may be provided in other forms, for example, the in-phase winding includes two insulating carrying plates. Specifically as shown in FIG. 8 and FIG. 9, FIG. 8 is a fourth radial cross-section schematic diagram of the first phase winding 110 in the winding stator provided in an embodiment of the present disclosure, and FIG. 9 is a fifth radial cross-section schematic diagram of the first phase winding 110 in the winding stator provided in an embodiment of the present disclosure. Specifically, the first phase winding 110 may include the first insulating carrying plate 111 and the fourth insulating carrying plate 112, the two insulating carrying plates are both provided with the serpentine coil 140, and each serpentine coil 140 may be spirally wound three turns and arranged on the corresponding insulating carrying plate. Moreover, the starting end 151 of the serpentine coil 140 on the first insulating carrying plate 111 is connected with the power supply terminal 146, the terminating end 152 of the serpentine coil 140 on the first insulating carrying plate 111 is connected in series with the starting end 151 of the serpentine coil 140 on the fourth insulating carrying plate 112, so as to form the winding stator.

It can be understood that based on the above manner of serial connection, the first insulating carrying plate 111, the fourth insulating carrying plate 112 and the serpentine coils 140 distributed on the two insulating carrying plates can form a single-phase winding stator, wherein the terminating end 152 of the serpentine coil 140 on the fourth insulating carrying plate 112 can act as a power supply output end to output a current, two serpentine coils 140, after being connected in series, can then share a voltage applied, so as to be capable of bearing a higher power voltage, further being helpful in realizing a design of a high-voltage electric motor using this winding stator. Besides, compared with the prior art, in a situation of bearing the same power voltage, the winding stator provided in the present solution can reduce the diameter of the coils, facilitating a miniaturized design of the electric motor.

In FIG. 8 and FIG. 9, the serpentine coil 140 on the first insulating carrying plate 111 can act as a first serpentine coil, the serpentine coil 140 on the fourth insulating carrying plate 112 can act as a second serpentine coil, and the terminating end 152 of the first serpentine coil can pass through the connection through hole 145 to be connected in series with the starting end 151 of the second serpentine coil. It can be understood that relative positions of the starting ends 151 and the terminating ends 152 on different insulating carrying plates may be slightly different, for example, the starting end 151 may be outside the serpentine coil 140, and also may be inside the serpentine coil 140.

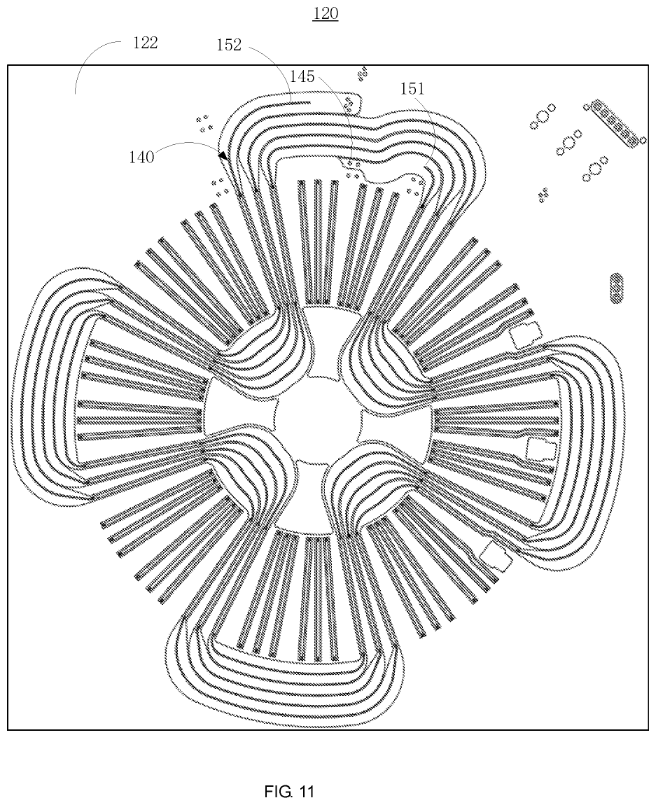

In the present embodiment, FIG. 10 is a second radial cross-section schematic diagram of the second phase winding 120 in the winding stator provided in an embodiment of the present disclosure, and FIG. 11 is a third radial cross-section schematic diagram of the second phase winding 120 in the winding stator provided in an embodiment of the present disclosure, wherein the second phase winding 120 may include a second insulating carrying plate 121 and a fifth insulating carrying plate 122. The structure and working principle of the second phase winding 120 are similar to the structure and working principle of the first phase winding 110 shown in FIG. 8 and FIG. 9, and reference can be made to the above detailed description of the specific structure and working principle of the first phase winding 110, which will not be repeated redundantly herein.

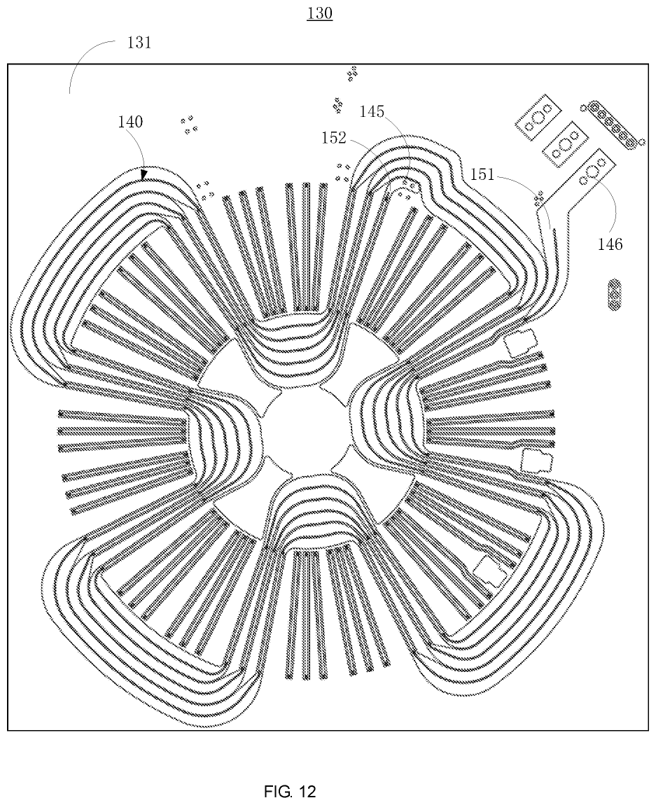

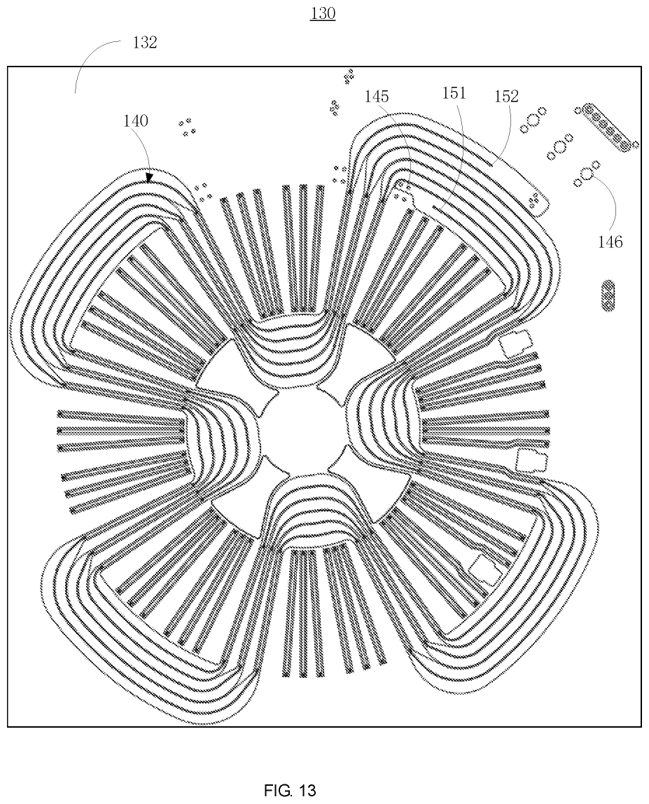

Similarly, in the present embodiment, FIG. 12 is a second radial cross-section schematic diagram of the third phase winding 130 in the winding stator provided in an embodiment of the present disclosure, and FIG. 13 is a third radial cross-section schematic diagram of the third phase winding 130 in the winding stator provided in an embodiment of the present disclosure, wherein the third phase winding 130 may include a third insulating carrying plate 131 and a sixth insulating carrying plate 132. The structure and working principle of the third phase winding 130 are similar to the structure and working principle of the first phase winding 110 shown in FIG. 8 and FIG. 9, and reference can be made to the above detailed description of the specific structure and working principle of the first phase winding 110, which will not be repeated redundantly herein.

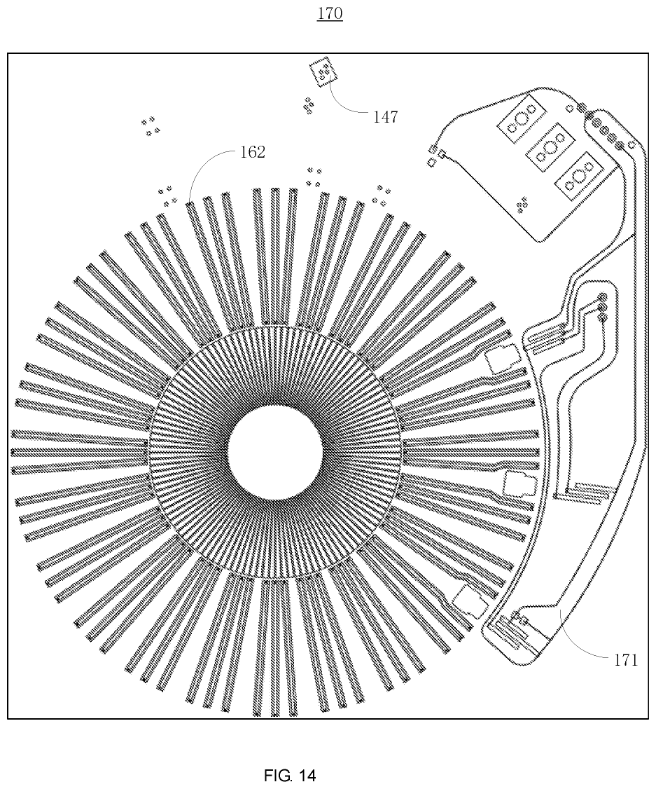

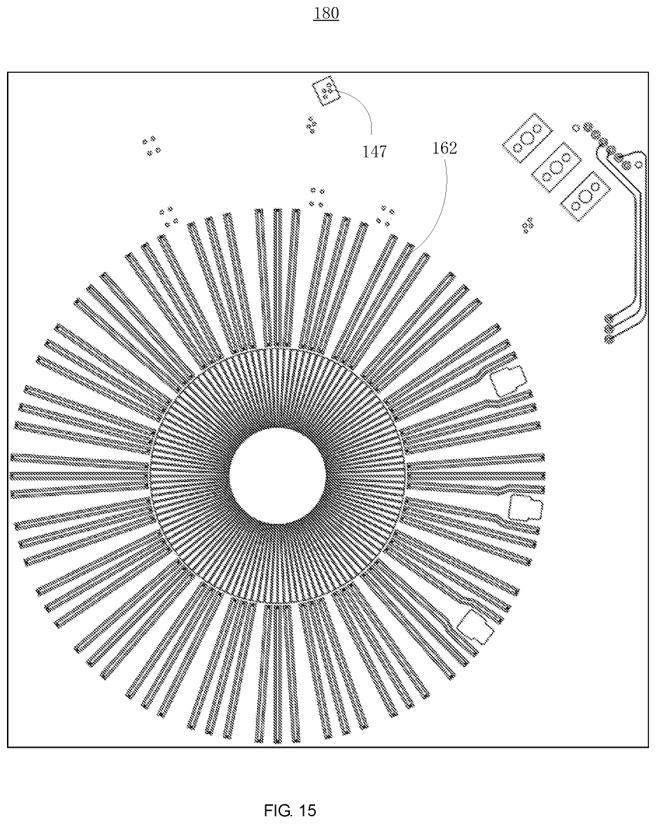

FIG. 14 is a radial cross-section schematic diagram of a Hall sensing layer 170 in the winding stator provided in an embodiment of the present disclosure, and FIG. 15 is a radial cross-section schematic diagram of a supplemental layer 180 in the winding stator provided in an embodiment of the present disclosure. As shown in FIG. 14 and FIG. 15, in the present embodiment, the winding stator further may include a Hall sensor 171, the Hall sensing layer 170 and the supplemental layer 180, and specifically, the Hall sensing layer 170 and the supplemental layer 180 are provided opposite at an interval, various phase windings are located between the Hall sensing layer 170 and the supplemental layer 180, and all of them are connected with the Hall sensor 171, wherein the Hall sensing layer 170 and the supplemental layer 180 are both configured to sense and transfer a pole alternating signal to the Hall sensor 171.

It can be understood that all of the structures (including the insulating carrying plates and the serpentine coils 140) shown in FIG. 8 to FIG. 13 can act as power layers of the winding stator, for driving the rotor to rotate, the Hall sensing layer 170 and the supplemental layer 180 can respectively act as bottom layer structure and top layer structure of the winding stator, and the Hall sensor 171 can serve a function of commutation. Generally, the position of the connection through hole 145 should be kept away from wires of the outward bent portions 142 of other power layers, and if the connection through hole 145 is located within ranges of wires on other layers, a periphery of the connection through hole 145 of the layer should be provided with an insulation region (non-copper region) for isolation, to prevent inter-wire short circuit.

It needs to be indicated that in order to ensure the same current direction of the radial working portions 143 at the same positions of various serpentine coils 140 in the same phase winding, the serpentine coils 140 on adjacent power layers in the same phase winding have opposite winding directions. For example, for the first phase winding 110, in FIG. 8, a direction of winding the serpentine coil 140 from an outer turn to an inner turn is a clockwise direction, and in FIG. 9, a direction of winding the serpentine coil 140 from an outer turn to an inner turn is an anticlockwise direction, on this basis, after two power layers are provided in a stacking manner, the radial working portions 143 of the two serpentine coils 140 at the same position have the same direction of current. For example, in FIG. 8, the current can flow clockwise from the outer turn to the inner turn of the serpentine coil 140, and correspondingly, in FIG. 9, the current can flow clockwise from the inner turn to the outer turn of the serpentine coil 140.

Please continuing to refer to FIG. 8 to FIG. 15, in the present embodiment, the insulating carrying plate can be provided with a plurality of non-conductive strip-shape slots 162, wherein the plurality of strip-shape slots 162 are arranged on the insulating carrying plate radially in a circular shape, and each of the working portion 143 is accommodated in at least part of the strip-shape slots 162 among the plurality of strip-shape slots 162.

It can be understood that the strip-shape slots 162 can function to fix and insulatedly isolate the working portions 143, so as to reduce deformation of the working portions 143 under the effect of Ampere force (a force received by an energized wire in a magnetic field). Besides, the strip-shape slots 162 not accommodating the working portions 143 can act as heat-dissipating slots, such that heat generated by the serpentine coil 140 in operation can be dissipated through the heat-dissipating slots, effectively improving the heat dissipating performance of the winding stator in the present embodiment.

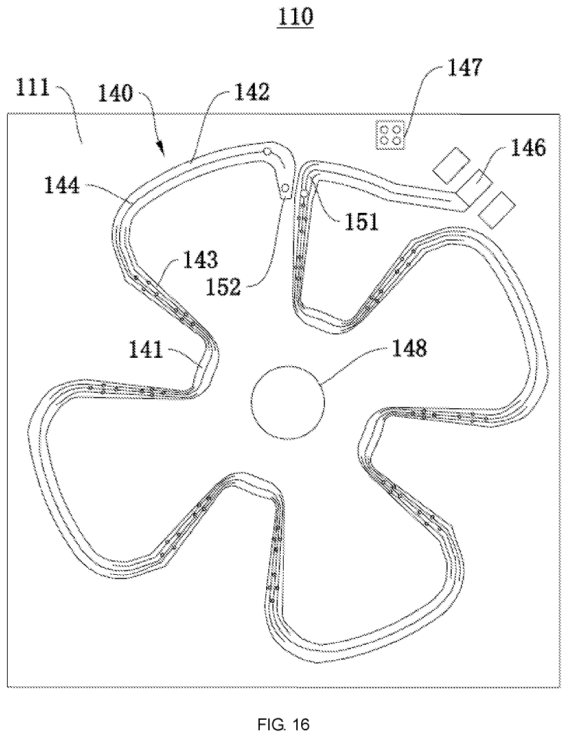

A solution of the winding stator in which the serpentine coils are connected in parallel is introduced below (corresponding to FIG. 16 to FIG. 20).

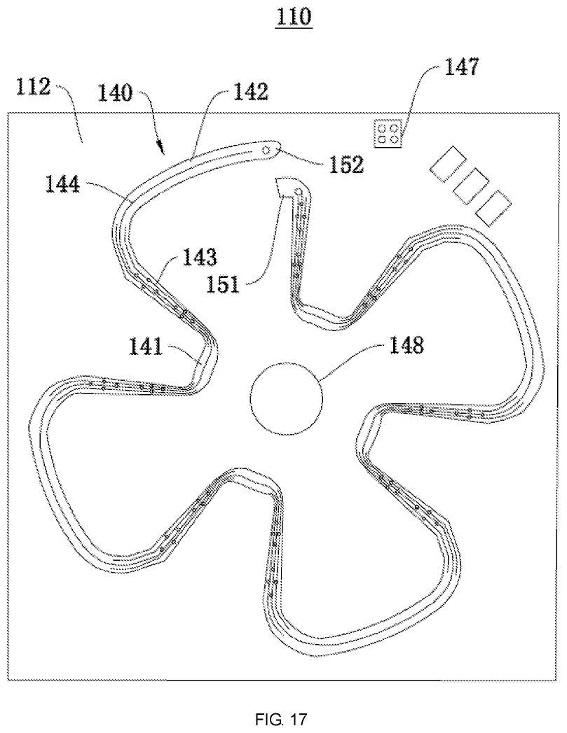

As shown in FIG. 16 and FIG. 17, FIG. 16 is a sixth radial cross-section schematic diagram of the first phase winding 110 in the winding stator provided in an embodiment of the present disclosure, and FIG. 17 is a seventh radial cross-section schematic diagram of the second phase winding 120 in the winding stator provided in an embodiment of the present disclosure. Such winding stator also includes at least one phase of winding, each phase of winding includes at least two insulating carrying plates and a serpentine coil 140 having a starting end 151 and a terminating end 152, wherein each insulating carrying plate is provided thereon with the serpentine coil 140, and the serpentine coil 140 is arranged on the insulating carrying plate in a shape of a bent spiral sheet, wherein the serpentine coil 140 also includes outward bent portions 142, inward bent portions 141 and working portions 143 located therebetween, wherein in the in-phase winding, the working portions 143 and the insulating carrying plate corresponding to the working portions 143 are both provided with at least one conductive through hole 191, wherein the at least one conductive through hole 191 is provided with a conductive connector in contact with the working portions 143 corresponding to the serpentine coil 140 on each layer, and the conductive connector is configured to connect the working portions 143 on adjacent insulating carrying plates in parallel.

The winding stator realizes parallel connection of the working portions 143 on adjacent insulating carrying plates through the conductive through holes 191 provided and the conductive connector provided, being helpful to reduce the manufacturing difficulty of the winding stator, and improve a rate of qualified stator products, thereby reducing the difficulty of the manufacturing process of the electric motors, and further facilitating cutting down the manufacturing cost of the electric motors.

Please continuing to refer to FIG. 16 and FIG. 17, the first phase winding 110 includes a first insulating carrying plate 111 and a fourth insulating carrying plate 112, moreover, the starting end 151 of the serpentine coil 140 on the first insulating carrying plate 111 is connected with the starting end 151 of the serpentine coil 140 on the fourth insulating carrying plate 112 and the power supply terminal 146, the terminating end 152 of the serpentine coil 140 on the first insulating carrying plate 111 is connected with the terminating end 152 of the serpentine coil 140 on the second insulating carrying plate 121, so as to connect two serpentine coils 140 in parallel to form the winding stator.

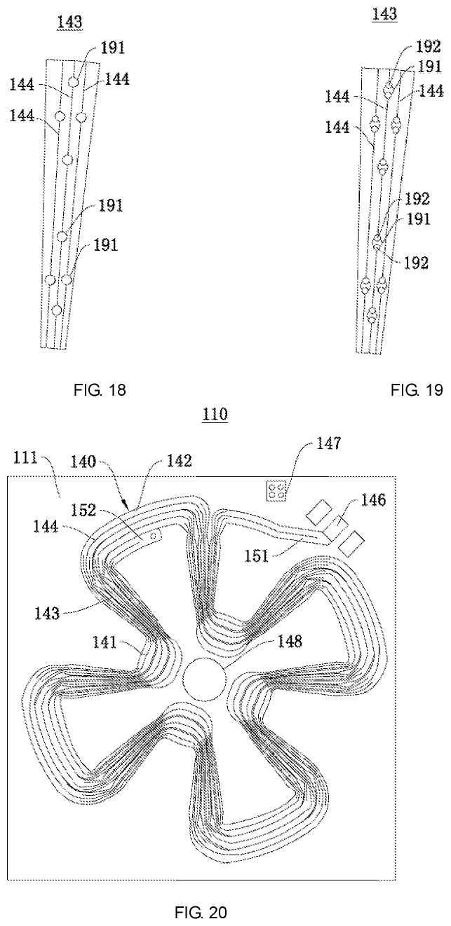

FIG. 18 is a third radial cross-section schematic diagram of the working portion 143 in the winding stator provided in an embodiment of the present disclosure, and FIG. 19 is a fourth radial cross-section schematic diagram of the working portion 143 in the winding stator provided in an embodiment of the present disclosure. As shown in FIG. 18 and FIG. 19, the conductive connector may be a conductive plating layer provided on an inner wall of the conductive through hole 191 on the insulating carrying plate, and the insulating carrying plate corresponding to an edge of the conductive through hole 191 is provided with at least one isolation through hole 192 configured to prevent the conductive connector from creating an eddy current loop. For example, the working portion 143 shown in FIG. 18 is not provided with an isolation through hole 192, while in the working portion 143 shown in FIG. 19, the edge of each conductive through hole 191 is provided with two isolation through holes 192, wherein the conductive plating layer may be a metal plating layer, and a metal material may be, but not limited to, copper, aluminum and so on. For example, the conductive plating layer may be a copper plating layer formed in the conductive through hole 191 through copper deposition.

It can be understood that if the conductive connector creates an eddy current loop, heat generated by the conductive connector will be increased. The isolation through hole 192 provided can reduce or prevent creation of the eddy current circuit, further facilitating reducing heat generated by the conductive connector, such that the electric energy can be converted to more mechanical energy, and output via the rotor, thereby being helpful in improving the electric motor's efficiency of converting electric energy to mechanical energy.

Besides, the number of conductive through hole 191 provided on the working portions 143 may be multiple, that is, the working portions 143 corresponding to the serpentine coils 140 on adjacent layers are connected in parallel through multiple conductive through holes 191. The parallel connection of the working portions 143 corresponding to adjacent layers realized through multiple points effectively increases a conductive cross section area, and reduces a contact resistance.

It can be understood that in the winding stator, the serpentine coils 140 of the in-phase winding are connected in parallel, such that various conductors connected in parallel can shunt the current, and further allow the winding stator to be capable of bearing a bigger current, facilitating the design of high-current electric motors.

FIG. 20 is an eighth radial cross-section schematic diagram of the first phase winding 110 in the winding stator provided in an embodiment of the present disclosure. Please continuing to refer to FIG. 16 in combination with FIG. 20, in the present embodiment, the serpentine coil 140 can be construed as a spiral sheet formed by bending a copper sheet back and forth into a circular shape, and the serpentine coil 140 also can act a serpentine sub coil. In FIG. 20, the serpentine coil 140 includes three serpentine sub coils concentrically connected in parallel end to end.

It can be understood that on the insulating carrying plate, a plurality of serpentine sub coils can be concentrically connected in series end to end to form the serpentine coil 140. The number of turns of serpentine coil 140 on the insulating carrying plate can be determined according to practical situations, and it may be one turn, and also can be multiple turns, and the number of turns is not specifically limited herein.

In the present embodiment, the winding stator may be a stator in a three-phase electric motor, that is, the number of the above in-phase windings may be three, the starting end 151 of each phase of winding may be respectively connected with a corresponding power supply terminal 146, and the terminating end 152 of each phase of winding is connected with the same three-phase neutral point 147, such that the three-phase coil windings are connected in a Y shape. It can be understood that the winding stator includes a first phase winding 110, a second phase winding 120 and a third phase winding 130, wherein the second phase winding 120 and the third phase winding 130 are structurally similar to the first phase winding 110, being in a winding form in which the serpentine coils 140 on adjacent layers are connected in parallel using the conductive through holes 191, and for specific structures thereof, reference can be made to detailed description of each structure of the first phase winding 110 in FIG. 16 to FIG. 20, which will not be repeated redundantly herein.

An embodiment of the present disclosure further provides an electric motor. The electric motor may include rotor disks provided opposite at an interval, and the above winding stator, wherein the winding stator is located between the two rotor disks.

It can be understood that a casing can serve a function of fixing and protecting the winding stator. Besides, as the electric motor uses the above winding stator, an internal resistance (or electric resistance) of the winding stator is reduced, further being capable of improving the electric motor's conversion efficiency of converting electric energy to mechanical energy. Moreover, when the technical solution in which the serpentine coils 140 on adjacent layers are connected in series to form the winding stator is used, the winding stator further can be allowed to bear a high voltage, and the number of turns of the serially connected windings of the electric motor can be increased without increasing a radial dimension of the stator, to realize the design of high-voltage electric motor with a relatively small dimension; when the technical solution in which the serpentine coils 140 on adjacent layers are connected in parallel to form the winding stator is used, the electric motor can connect all power layers, thus increasing an area of the working portions, reducing a electric resistance of the electric motor, and improving the efficiency of the electric motor.

The above-mentioned are merely for preferred embodiments of the present disclosure and not intended to limit the present disclosure. For one skilled in the art, various modifications and variations may be made to the present disclosure. Any amendments, equivalent replacements, improvements and so on, within the spirit and principle of the present disclosure, should be covered within the scope of protection of the present disclosure.

### INDUSTRIAL APPLICABILITY

The winding stator and the electric motor provided in the present disclosure are allowed to have a reduced internal resistance of the winding stator, so as to improve the electric motor's conversion efficiency of converting electric energy to mechanical energy. Moreover, the number of turns of the serially connected windings of the electric motor can be increased without increasing a radial dimension of the stator, to realize the design of high-voltage electric motor with a relatively small dimension. Besides, all power layers also can be connected, thus increasing an area of the working portions, reducing an electric resistance of the electric motor, and improving the efficiency of the electric motor.

1. A winding stator, applicable to an electric motor, the winding stator comprising at least one phase of windings, each phase of windings comprising at least one insulating carrying plate and at least one serpentine coil having a starting end and a terminating end, each of the at least one insulating carrying plate being provided with one of the at least one serpentine coil, and each of the at least one serpentine coil being arranged on the corresponding one of the at least one insulating carrying plate in a shape of bent spiral sheet, wherein each of the at least one serpentine coil comprises inward bent portions, outward bent portions and working portions, each of the working portions is in a fan-shaped sheet-like structure, an inner arc end of the fan-shaped sheet-like structure is connected with one of the inward bent portions, and an outer arc end of the fan-shaped sheet-like structure is connected with one of the outward bent portions.

2. The winding stator according to claim 1, wherein each of the at least one serpentine coil is provided with at least one hollowed gap, and the at least one hollowed gap is configured to divide the corresponding one of the at least one serpentine coil into a plurality of sheet-like conductors connected in parallel.

3. The winding stator according to claim 2, wherein each of the at least one hollowed gap is provided with an insulation material configured to insulatedly isolate conductors at two sides of the hollowed gap.

4. The winding stator according to claim 1, wherein the outer arc end of the fan-shaped sheet-like structure is in a form of a trapezoidal sheet, a length of an upper base of the trapezoidal sheet is smaller than a length of a lower base of the trapezoidal sheet, and an upper base side of the trapezoidal sheet is connected with one of the outward bent portions.

5. The winding stator according to claim 1, wherein each phase of the windings comprises a plurality of serpentine coils and a plurality of insulating carrying plates respectively configured to carry the plurality of serpentine coils, and in in-phase windings, the plurality of serpentine coils, by means of making corresponding starting ends and respective terminating ends in a serial or parallel connection, form the winding stator.

6. The winding stator according to claim 1, wherein the number of the at least one insulating carrying plate is multiple; in in-phase windings, each of the insulating carrying plates is provided with a connection through hole, and the connection through hole is configured for serial connection of the serpentine coils on the insulating carrying plates in the in-phase windings.

7. The winding stator according to claim 6, wherein each of the insulating carrying plates is provided with a plurality of strip-shape slots, the plurality of strip-shape slots are arranged on the corresponding insulating carrying plate radially in a circular shape, and the working portions are accommodated in at least part of the plurality of strip-shape slots.

8. The winding stator according to claim 1, wherein the number of the at least one insulating carrying plate is multiple; in in-phase windings, the working portions and one of the insulating carrying plates corresponding to the working portions are both provided with at least one conductive through hole, wherein each of the at least one conductive through hole is provided with a conductive connector in contact with the working portions corresponding to the serpentine coil on each layer, and the conductive connector is configured to connect the working portions on adjacent insulating carrying plates in parallel.

9. The winding stator according to claim 7, wherein the conductive connector is a conductive plating layer provided on an inner wall of each of the at least one conductive through hole, and the insulating carrying plate corresponding to an edge of the conductive through hole is provided with at least one isolation through hole configured to prevent the conductive connector from creating an eddy current loop.

10. The winding stator according to claim 1, wherein the phase number of the windings is three, individual serpentine coils of in-phase windings are distributed on a radial cross section in the same manner, windings in different phases are distributed on a radial cross section with an angle of 120° therebetween, and connected in a Y shape.

11. The winding stator according to claim 1, wherein the in-phase windings further are provided with a power supply terminal, and the power supply terminal is connected with the starting end or the terminating end.

12. The winding stator according to claim 1, wherein the at least one insulating carrying plate is a PCB board, and the PCB board is provided with an axial hole allowing a rotor of the electric motor to pass therethrough.

13. The winding stator according to claim 1, wherein the winding stator further comprises a Hall sensing layer, a supplemental layer and a Hall sensor, the Hall sensing layer and the supplemental layer are provided opposite and separated from each other, individual phases of the windings are located between the Hall sensing layer and the supplemental layer, and all of them are connected with the Hall sensor, and the Hall sensing layer and the supplemental layer are both configured to sense a pole alternating signal and transfer the pole alternating signal to the Hall sensor.

14. The winding stator according to claim 1, wherein each of the at least one insulating carrying plate is provided with a plurality of heat-dissipating parts, and the plurality of heat-dissipating parts are configured to transfer heat generated by the serpentine coil to the corresponding insulating carrying plate.

15. An electric motor, comprising rotor disks provided opposite and the winding stator according to claim 1, the winding stator being located between the rotor disks.

16. The winding stator according to claim 2, wherein each phase of the windings comprises a plurality of serpentine coils and a plurality of insulating carrying plates respectively configured to carry the plurality of serpentine coils, and in in-phase windings, the plurality of serpentine coils, by means of making corresponding starting ends and respective terminating ends in a serial or parallel connection, form the winding stator.

17. The winding stator according to claim 3, wherein each phase of the windings comprises a plurality of serpentine coils and a plurality of insulating carrying plates respectively configured to carry the plurality of serpentine coils, and in in-phase windings, the plurality of serpentine coils, by means of making corresponding starting ends and respective terminating ends in a serial or parallel connection, form the winding stator.

18. The winding stator according to claim 4, wherein each phase of the windings comprises a plurality of serpentine coils and a plurality of insulating carrying plates respectively configured to carry the plurality of serpentine coils, and in in-phase windings, the plurality of serpentine coils, by means of making corresponding starting ends and respective terminating ends in a serial or parallel connection, form the winding stator.

19. The winding stator according to claim 2, wherein the number of the at least one insulating carrying plate is multiple; in in-phase windings, each of the insulating carrying plates is provided with a connection through hole, and the connection through hole is configured for serial connection of the serpentine coils on the insulating carrying plates in the in-phase windings.

20. The winding stator according to claim 3, wherein the number of the at least one insulating carrying plate is multiple; in in-phase windings, each of the insulating carrying plates is provided with a connection through hole, and the connection through hole is configured for serial connection of the serpentine coils on the insulating carrying plates in the in-phase windings.
